(19) United States
(12) Patent Application Publication
(10) Pub. No.: US 2003/0110056 A1
(43) Pub. Date: Jun. 12, 2003

(54) Method for rating items within a recommendation system based on additional knowledge of item relationships

(75) Inventors: Frank Berghofer, Nidderau (DE); Gerhard Schrimpf, Hosenfeld (DE); Hermann Stamm-Wilbrandt, Eberbach (DE); Lars Gendner, Berlin (DE); Michael Tsakonas, Berlin (DE)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/282,965

(22) Filed: Oct. 29, 2002

(30) Foreign Application Priority Data
Oct. 31, 2001 (EP) 01125973.6

(51) Int. Cl. G06F 17/60

(52) U.S. Cl. 705/1

(57) ABSTRACT

A computerized method and corresponding means for rating an item within a recommendation system, that exploits additional external knowledge or the relationships between the ratable items to implicitly derive, from a first item rated explicitly by a certain user, implicit ratings for items related to the explicitly rated item. In response to a first explicit rating for a first item, the following steps are performed: determining, for the first item, a first set related items based on a predefined item relationship; storing, within the recommendation system, the first explicit rating of the first item; and storing, within the recommendation system, first implicit ratings for the first set of related items.

### FIELD OF THE INVENTION

The present invention relates to means and a method for recommending items to a given user based on item recommendations of the same and other users of the system. More particularly the current invention relates to a technology for improving the quality of recommendations and for extending the scope of potential recommendations.

### BACKGROUND

A new area of technology with increasing importance is the domain “collaborative filtering” or “social filtering” of information. These technologies represent novel approaches to information filtering that do not rely on the “contents” of objects as is the case for content-based filtering. Instead, filtering relies on meta-data “about” objects. This meta data may be either collected automatically, that is data is inferred from users' interactions with the system (for instance by the time spent reading articles as an indicator of interest), or may be voluntarily provided by the users of the system. In essence, the main idea is to automate the process of “word-of-mouth” by which people recommend products or services to one another.

A person who needs to choose between a variety of unfamiliar options will often rely on the opinions of others who do have relevant experience. However, when there are thousands or millions of options, like in the Web, it becomes practically impossible for an individual to locate reliable experts that can give advice about each of the options. By shifting from an individual to a collective method of recommendation, the problem becomes more manageable.

Instead of asking for the opinion of each individual, one might try to determine an “average opinion” for the group. This, however, ignores a given person's particular interests, which may be different from those of the “average person”. Therefore one would rather like to hear the opinions of those people who have interests similar to one's own, that is to say, one would prefer a “division-of-labor” type of organization, where people only contribute to the domain they are specialized in.

The basic mechanism behind collaborative filtering systems is the following:

a large group of people's preferences are registered;

using a similarity metric, a subgroup is selected whose preferences are similar to the preferences of the person who seeks advice;

a (possibly weighted) average of the preferences for that subgroup is calculated;

the resulting preference function is used to recommend options on which the advice-seeker has expressed no personal opinion yet.

Typical similarity metrics are Pearson correlation coefficients between the users' preference functions and (less frequently) vector distances or dot products. If the similarity metric has indeed selected people with similar tastes, the chances are great that the options that are highly evaluated by that group will also be appreciated by the advice-seeker.

A typical application is the recommendation of books, music CDs, or movies. More generally, the method can be used for the selection of documents, services, products of any kind, or in general any type of resource.

In the world outside the Internet, rating and recommendations are provided by services such as:

Newspapers, magazines, books, which provide ratings by their editors or publishers, who select information which they think their readers want.

Consumer organizations and trade magazines which evaluate and rate products.

Published reviews of books, music, theater, films, etc.

Peer review method of selecting submissions to scientific journals.

Examples for these technologies are for instance the teachings of John B. Hey, “System and method of predicting subjective reactions,” U.S. Pat. No. 4,870,579 or John B. Hey, “System and method for recommending items”, U.S. Pat. No. 4,996,642, both assigned to Neonics Inc., as well as Christopher P. Bergh, Max E. Metral, David Henry Ritter, Jonathan Ari Sheena, James J. Sullivan, “Distributed system for facilitating exchange of user information and opinion using automated collaborative filtering”, U.S. Pat. No. 6,112,186, assigned to Microsoft Corporation.

In spite all these advances and especially due to the increased importance of the Internet, which provides the access technology and communication infrastructure to recommendation systems, there is still a need in the art for improvement.

### SUMMARY

An object of the invention is to improve the quality of the individual recommendations of recommendation systems without degradation of performance.

A further objective of the current invention is to compensate for the apparent reluctance of most users to give sufficient information, either because of workload or privacy concerns.

Yet another objective is to increase the scope for potential recommendations which is limited by current state of the art technology wherein users are characterized only by their individual ratings.

The present invention includes means and a computerized method for rating an item within a recommendation system. The invention exploits additional external knowledge of the relationships between the ratable items to implicitly derive, from a first item rated explicitly by a certain user, implicit ratings for items related to the explicitly rated item.

Thus, in response to a first explicit rating for a first item the following steps are included: determining for the first item a first set of related items based on a predefined item relationship, storing within the recommendation system the first explicit rating of the first item, and storing within the recommendation system also first implicit ratings for the first set of related items.

Thus, the current invention provides access to additional implicit rating information which is enclosed within a single rating received by a certain user. The implicit external knowledge of the relationship of items participating within the recommendation system allows characterization of a certain user who has rated a specific, individual item by further implicit, or derived, ratings of additional items having a predefined relationship with the concrete rated item. This results in a much more precise “picture” of each individual user even when users are reluctant to provide explicit ratings for items. The invention results in a more extensive characterization of an individual user, which provides a significant advantage in determining similar users within the recommendation system. In other words, similarity determination significantly benefits from the implicit rating information. Being able to determine users which are more similar to a certain user has the advantage that a significantly extended scope of potential recommendations can be determined. Finally, these techniques improve the quality of the individual recommendations considerably.

### BRIEF DESCRIPTION OF THE DRAWINGS

FIG. 1 gives an overview of the concepts of recommendation systems.

FIG. 2 depicts a preferred layout of a data structure common to user profiles and item profiles according to the current invention.

FIG. 3 shows an example of the combination of user profiles and item profiles reflecting a two dimensional linkage.

FIG. 4 visualizes one embodiment of a predefined relationship between items in the form of a hierarchy.

FIG. 5 shows an example of explicit ratings of items by a user.

FIG. 6 visualizes two different embodiments non-additive and an additive one) dealing with the problem of how two sets of related items resulting from two different explicitly rated items may be combined into a resulting rating within the user/item profiles.

FIG. 7 shows steps of the proposed methodology for deriving implicit ratings for items relating to an explicitly rated item.

### DETAILED DESCRIPTION

The drawings and specification set forth a preferred embodiment of the invention. Although specific terms are used, the description thus given uses terminology in a generic and descriptive sense only, and not for purposes of limitation. It will, however, be evident that various modifications and changes may be made thereto without departing from the broader spirit and scope of the invention as set forth in the appended claims.

The present invention can be realized in hardware, software, or a combination of hardware and software. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when being loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

As referred to in this description, items to be recommended can be objects of any type. As mentioned above, an item may refer to any type of resource one can think of.

The following is a short outline of the basic concepts of recommendation systems.

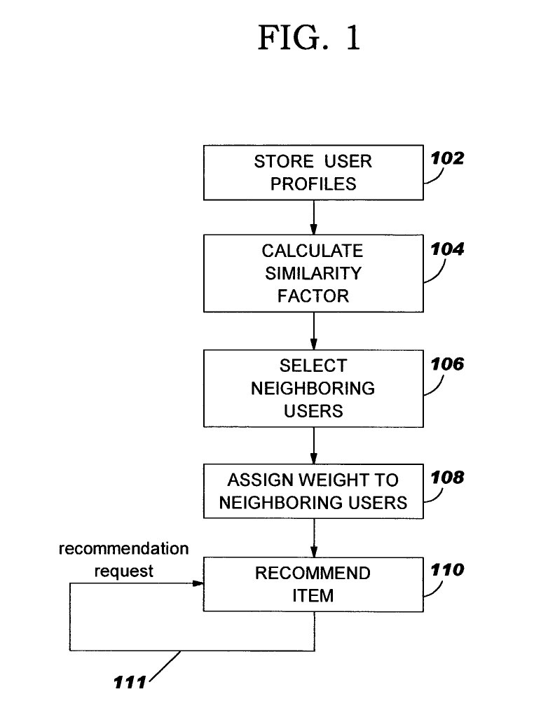

Referring now to FIG. 1, a method for recommending items begins by storing user and item information in profiles.

A plurality of user profiles are stored in a memory (step 102). One profile may be created for each user or multiple profiles may be created for a user to represent that user over multiple domains. Alternatively, a user may be represented in one domain by multiple profiles where each profile represents the proclivities of a user in a given set of circumstances. For example, a user that avoids seafood restaurants on Fridays, but not on other days of the week, could have one profile representing the user's restaurant preferences from Saturday through Thursday, and a second profile representing the user's restaurant preferences on Fridays. In some embodiments, a user profile represents more than one user. For example, a profile may be created which represents a woman and her husband for the purpose of selecting movies. Using this profile allows a movie recommendation to be given which takes into account the movie tastes of both individuals.

For convenience, the remainder of this specification will use the term “user” to refer to single users of the system, as well as “composite users.” The memory can be any memory known in the art that is capable of storing user profile data and allowing the user profiles to be updated, such as disc drive or random access memory.

Each user profile associates items with the ratings given to those items by the user. Each user profile may also store information in addition to the user's rating. In one embodiment, the user profile stores information about the user, e.g. name, address, or age. In another embodiment, the user profile stores information about the rating, such as the time and date the user entered the rating for the item. User profiles can be any data construct that facilitates these associations, such as an array, although it is preferred to provide user profiles as sparse vectors of n-tuples. Each n-tuple contains at least an identifier representing the rated item and an identifier representing the rating that the user gave to the item, and may include any number of additional pieces of information regarding the item, the rating, or both. Some of the additional pieces of information stored in a user profile may be calculated based on other information in the profile. For example, an average rating for a particular selection of items (e.g., heavy metal albums) may be calculated and stored in the user's profile. In some embodiments, the profiles are provided as ordered n-tuples.

Whenever a user profile is created, a number of initial ratings for items may be solicited from the user. This can be done by providing the user with a particular set of items to rate corresponding to a particular group of items. Groups are genres of items and are discussed below in more detail. Other methods of soliciting ratings from the user may include: manual entry of item-rating pairs, in which the user simply submits a list of items and ratings assigned to those items; soliciting ratings by date of entry into the system, i.e., asking the user to rate the newest items added to the system; soliciting ratings for the items having the most ratings; or by allowing a user to rate items similar to an initial item selected by the user. In still other embodiments, the system may acquire a number of ratings by monitoring the user's environment. For example, the system may assume that Web sites for which the user has created “bookmarks” are liked by that user, and may use those sites as initial entries in the user's profile. One embodiment includes all of the methods described above and allows the user to select the particular method they wish to employ.

Ratings for items which are received from users can be of any form that allows users to record subjective impressions of items based on their experience of the item. For example, items may be rated on an alphabetic scale (“A” to “F”) or a numerical scale (1 to 10). In one embodiment, ratings are integers between 1 (lowest) and 7 (highest).

Any technology may be exploited to input these ratings into a computer system. Ratings even can be inferred by the system from the user's usage pattern. For example, the system may monitor how long the user views a particular Web page and store in that user's profile an indication that the user likes the page, assuming that the longer the user views the page, the more the user likes the page. Alternatively, a system may monitor the user's actions to determine a rating of a particular item for the user. For example, the system may infer that a user likes an item which the user mails to many people, and enter in the user's profile an indication that the user likes that item. More than one aspect of user behavior may be monitored in order to infer ratings for that user, and in some embodiments, the system may have a higher confidence factor for a rating which it inferred by monitoring multiple aspects of user behavior. Confidence factors are discussed in more detail below.

Profiles for each item that has been rated by at least one user may also be stored in memory. Each item profile records how particular users have rated this particular item. Any data construct that associates ratings given to the item with the user assigning the rating can be used. It is preferable to provide item profiles as a sparse vector of n-tuples. Each n-tuple contains at least an identifier representing a particular user and an identifier representing the rating that user gave to the item, and it may contain other information, as described above in connection with user profiles.

The additional information associated with each item-rating pair can be used by the system for a variety of purposes, such as assessing the validity of the rating data. For example, if the system records the time and date the rating was entered, or inferred from the user's environment, it can determine the age of a rating for an item. A rating which is very old may indicate that the rating is less valid than a rating entered recently. For example, users' tastes may change or “drift” over time. One of the fields of the n-tuple may represent whether the rating was entered by the user or inferred by the system. Ratings that are inferred by the system may be assumed to be less valid than ratings that are actually entered by the user. Other items of information may be stored, and any combination or subset of additional information may be used to assess rating validity. In some embodiments, this validity metric may be represented as a confidence factor, that is, the combined effect of the selected pieces of information recorded in the n-tuple may be quantified as a number. In some embodiments, that number may be expressed as a percentage representing the probability that the associated rating is incorrect or as an expected deviation of the predicted rating from the “correct” value.

The user profiles are accessed in order to calculate a similarity factor for each certain user with respect to all other users (step 104). A similarity factor represents the degree of correlation between any two users with respect to the set of items. The calculation to be performed may be selected such that the more two users correlate, the closer the similarity factor is to zero.

Whenever a rating is received from a user or is inferred by the system from that user's behavior, the profile of that user may be updated as well as the profile of the item rated. Profile updates may be stored in a temporary memory location and entered at a convenient time or profiles may be updated whenever a new rating is entered by or inferred for that user. Profiles can be updated by appending a new n-tuple of values to the set of already existing n-tuples in the profile or, if the new rating is a change to an existing rating, overwriting the appropriate entry in the user profile. Updating a profile also requires re-computation of any profile entries that are based on other information in the profile.

Especially whenever a user's profile is updated with new rating-item n-tuple, new similarity factors between the user and other users of this system should be calculated. In other embodiments, similarity factors are periodically recalculated, or recalculated in response to some other stimulus, such as a change in a neighboring user's profile.

The similarity factors for a user are calculated by comparing that user's profile with the profile of every other user of the system. This is computationally intensive, since the order of computation for calculating similarity factors in this manner is n², where n is the number of users of the system. It is possible to reduce the computational load associated with recalculating similarity factors in embodiments that store item profiles by first retrieving the profiles of the newly-rated item and determining which other users have already rated that item. The similarity factors between the newly-rating user and the users that have already rated the item are the only similarity factors updated. In general, a method for calculating similarity factors between users should minimize the deviation between a predicted rating for an item and the rating a user would actually have given the item.

Similarity factors between users refer to any quantity which expresses the degree of correlation between two users' profiles for a particular set of items. The following methods for calculating the similarity factor are intended to be exemplary, and in no way exhaustive. Depending on the item domain, different methods will produce optimal results, since users in different domains may have different expectations for rating accuracy or speed of recommendations. Different methods may be used in a single domain, and, in some embodiments, the system allows users to select the method by which they want their similarity factors produced.

In the following description of methods, D_{xy} represents the similarity factor calculated between two users, x and y. Hᵢₓ represents the rating given to item i by user x, I represents all items in the database, and Cᵢₓ is a Boolean quantity which is 1 if user x has rated item i and 0 if user x has not rated that item.

One method of calculating the similarity between a pair of users is to calculate the average squared difference between their ratings for mutually rated items. Thus, the similarity factor between user x and user y is calculated by subtracting, for each item rated by both users, the rating given to an item by user y from the rating given to that same item by user x and squaring the difference. The squared differences are summed and divided by the total number of items rated. This method is represented mathematically by the following expression:

$${D}_{xy} = \frac{{\sum }_{i ∈ I} {( {c}_{ix} ( {c}_{iy} ( {H}_{ix} - {H}_{iy} ) ) )}^{2}}{{\sum }_{i ∈ I} {c}_{ix} {c}_{iy}}$$

A similar method of calculating the similarity factor between a pair of users is to divide the sum of their squared rating differences by the number of items rated by both users raised to a power. This method is represented by the following mathematical expression:

$${D}_{xy} = \frac{{\sum }_{i ∈ {C}_{xy}} {( {H}_{ix} - {H}_{iy} )}^{2}}{{\vert {C}_{xy} \vert}^{k}}$$

where |C_{xy}| represents the number of items rated by both users.

A third method for calculating the similarity factor between users factors into the calculation the degree of profile overlap, i.e. the number of items rated by both users compared with the total number of items rated by either one user or the other. Thus, for each item rated by both users, the rating given to an item by user y is subtracted from the rating given to that same item by user x.

These differences are squared and then summed. The amount of profile overlap is taken into account by dividing the sum of squared rating differences by a quantity equal to the number of items mutually rated by the users subtracted from the sum of the number of items rated by user x and the number of items rated by users y. This method is expressed mathematically by:

$${D}_{xy} = \frac{{\sum }_{i ∈ Cxy} {( {H}_{ix} - {H}_{iy} )}^{2}}{{\sum }_{i ∈ I} {c}_{ix} + {\sum }_{i ∈ I} {c}_{iy} - \vert {C}_{xy} \vert}$$

where |C_{xy}| represents the number of items mutually rated by users x and y.

In another embodiment, the similarity factor between two users is a Pearson r correlation coefficient. Alternatively, the similarity factor may be calculated by constraining the correlation coefficient with a predetermined average rating value, A. Using the constrained method, the correlation coefficient, which represents D_{xy}, is arrived at in the following manner. For each item rated by both users, A is subtracted from the rating given to the item by user x and the rating given to that same item by user y. Those differences are then multiplied. The summed product of rating differences is divided by the product of two sums. The first sum is the sum of the squared differences of the predefined average rating value, A, and the rating given to each item by user x. The second sum is the sum of the squared differences of the predefined average value, A, and the rating given to each item by user y. This method is expressed mathematically by:

$${D}_{xy} = \frac{{\sum }_{i ∈ Cxy} ( {H}_{ix} - A ) ( {H}_{iy} - A )}{{\sum }_{i ∈ {U}_{x}} {( {H}_{ix} - A )}^{2} + {\sum }_{i ∈ {U}_{y}} {( {H}_{iy} - A )}^{2}}$$

where Uₓ represents all items rated by x, U_{y} represents all items rated by y, and C_{xy} represents all items rated by both x and y.

The additional information included in a n-tuple may also be used when calculating the similarity factor between two users. For example, the information may be considered separately in order to distinguish between users, e.g. if a user tends to rate items only at night and another user tends to rate items only during the day, the users may be considered dissimilar to some degree, regardless of the fact that they may have rated an identical set of items identically.

Regardless of the method used to generate them, or whether the additional information contained in the profiles is used, the similarity factors are used to select a plurality of users that have a high degree of correlation to a user (step 106). These users are called the user's “neighboring users.” A user may be selected as a neighboring user if that user's similarity factor with respect to the requesting user is better than a predetermined threshold value, L. The threshold value, L, can be set to any value which improves the predictive capability of the method. In general, the value of L will change depending on the method used to calculate the similarity factors, the item domain, and the size of the number of ratings that have been entered. In another embodiment, a predetermined number of users are selected from the users having a similarity factor better than L, e.g. the top twenty-five users. For embodiments in which confidence factors are calculated for each user-user similarity factor, the neighboring users can be selected based on having both a threshold value less than L and a confidence factor higher than a second predetermined threshold.

A user's neighboring user set should be updated each time that a new rating is entered by, or inferred for, that user. This requires determination of the identity of the neighboring users as well as all the similarity factors between the given user and its neighboring users. Moreover, due to the update of a certain rating of a first user the set of neighboring users of a multitude of other users should be changed. For instance this first user might have to be introduced or removed as a member of the set of neighboring users of other users, in which case the involved similarity factors should be re-computed.

With increasing numbers of users and increased exploitations of recommendation systems, this requirement for continuous recomputation of precomputed neighboring users and their similarity factors becomes a real processing burden for such systems. Thus in many applications it is desirable to reduce the amount of computation required to maintain the appropriate set of neighboring users by limiting the number of user profiles consulted to create the set of neighboring users. In one embodiment, instead of updating the similarity factors between a rating user and every other user of the system (which has computational order of n²), only the similarity factors between the rating user and the rating user's neighbors, as well as the similarity factors between the rating user and the neighbors of the rating user's neighbors are updated. This limits the number of user profiles which must be compared to m² minus any degree of user overlap between the neighbor sets where m is a number smaller than n.

Once a set of neighboring users is chosen, a weight is assigned to each of the neighboring users (step 108). In one embodiment, the weights are assigned by subtracting the similarity factor calculated for each neighboring user from the threshold value and dividing by the threshold value. This provides a user weight that is higher, i.e. closer to one, when the similarity factor between two users is smaller. Thus, similar users are weighted more heavily than other, less similar, users. In other embodiments, the confidence factor can be used as the weight for the neighboring users. Of course many other approaches may be chosen to assign weights to neighboring users based on the calculated similarity factors.

Once weights are assigned to the neighboring users, an item is recommended to a user (step 110). For applications in which positive item recommendations are desired, items are recommended if the user's neighboring users have also rated the item highly. For an application desiring to warn users away from items, items are displayed as recommended against when the user's neighboring users have also given poor ratings to the item.

As indicated already above, recommendation systems servicing a large number of users with a high-frequency of updating their rating values create a significant computation burden for the allocation of the precomputed similarity factors and neighboring users. Within the state of the art it is thus suggested that the similarity factors are recalculated periodically only or are recalculated only in response to some other stimulus. This approach is reflected within FIG. 1 showing that the steps 102 up to 110 to calculate the precomputed neighboring users (comprising similarity factors, weights and the neighboring users themselves) are performed only once (or at least with a low frequency) and provide a static basis for processing of a huge multitude of individual recommendation requests within step 111.

The most critical points in generating matchings and/or recommendations is efficiency or in other words the performance of such a system. This efficiency aspect will be experienced by a user in terms of the system's latency, i.e. the required processing time of a user's recommendation request. From the perspective of recommendation systems themselves the efficiency aspect is related to the frequency in which recommendation requests are entered into recommendation systems for processing. For online businesses latency in the sub-second area is a must.

In European patent application with the application number 01111407.1 of IBM as applicant, another type of recommendation system is disclosed avoiding the requirement of creation and maintenance of static, precomputed similarity factors stored persistently. This teaching suggests computing, on a temporary basis only for each individual recommendation request of a certain user, the similarity factors measuring the similarity between said certain user and the multitude of users. Such techniques may be applied to the current invention as well, as the current invention is independent of the specific technique of how and when similarity factors are calculated.

One example of a potentially more detailed structure of the various profiles (user profiles, item profiles) is discussed next.

In this exemplary embodiment, the combination of user profiles and item profiles includes a multitude of identical data structures, each comprising at least a user identification and an item identification, and a corresponding rating value (potentially enhanced with computed similarity factors). For efficient use of the computer's memory, this common data structure should be limited in size.

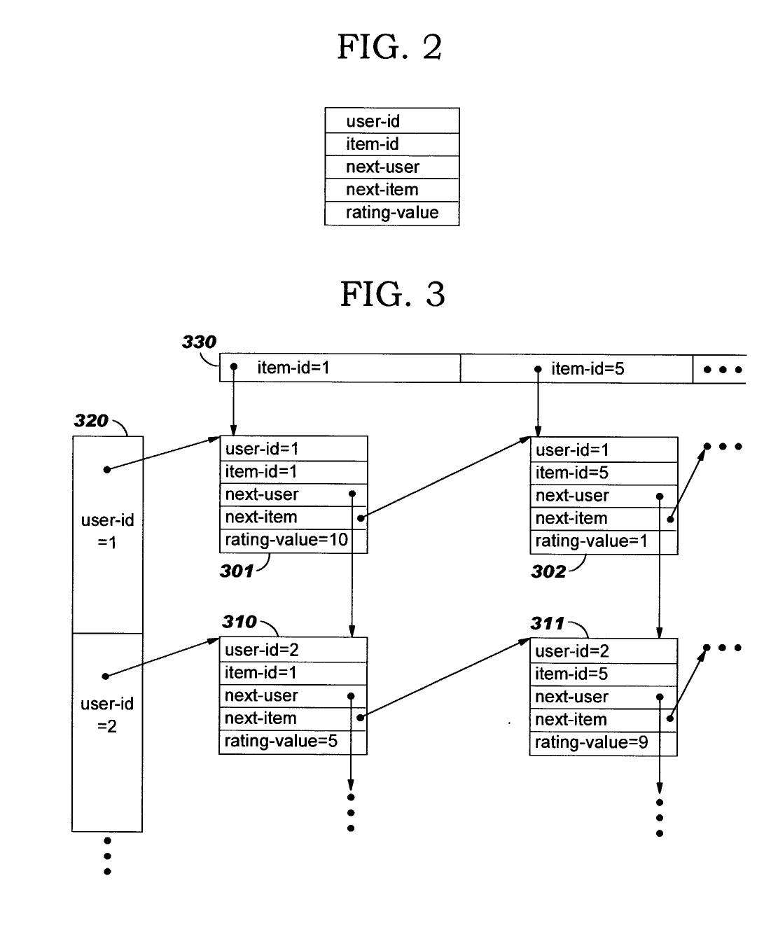

A potential layout of this data structure common to user profiles and item profiles is depicted in FIG. 2. Each rating or normull matrix entry is represented by a tuple comprising as least the following data elements:

user-id: identification of a certain user

item-id: identification of a certain item

Next-user: a link to an identical data structure characterizing the next user in a sequence according the user-ids

Next-item: a link to an identical data structure characterizing the next item in a sequence according the item-ids

rating value: the rating value of the item characterized by an item-id provided by a user characterized by a user-id.

Of course this list may be enhanced by similarity factors computed by comparing the ratings of the various users.

To allow these data structures to be searched easily by the computer system, they are linked in two dimensions, resulting in a matrix-like structure. FIG. 3 shows an example of the combination of user profiles and item profiles reflecting the two dimensional linkage. The first dimension 320 links all data structures with the same user identification in a sequence according to the item identifications (user profile). The second dimension 330 links all data structures with the same item identification in a sequence according to the user identifications (item profile). Referring to FIG. 3 examples of the basic data structure are depicted by 301, 302, 310, 311. In the horizontal dimension these elementary data structures are linked so that each row represents the user profile. In the vertical dimension these elementary data structures are all linked so that each column represents one item profile.

Fundamental Observations And Basic Approach

The following observations provide a deeper insight into the problems with the state of the art. These observations further reveal the cause of these problems and, in a step by step process, help explain the solution proposed by the current invention.

A serious deficiency of the state of the art relates to poor recommendation quality due to an inadequate amount of rating information from users. It therefore acknowledges the reluctance of most humans to give much information, either because of workload or privacy concerns. In other cases, users are not aware of the type of information needed by a recommendation system to help improve the recommendation quality.

The fundamental observation of the current invention is that every explicit rating of a certain item received by a user actually provides additional, implicit information as well, as every item has certain relationships with other items. Thus, upon receiving an explicit rating on a certain item, it is possible to implicitly rate related items depending on their relationship to the explicitly rated item. It is further suggested that the value of this implicit rating depends on the closeness of the explicitly rated and the implicitly rated item. In other words, it depends on the proximity distance in accordance with the predefined relationships structuring the multitude of the ratable items.

For example, the items representing each entry in a news forum have a hierarchical relation. On top there is the news system as a whole. On the next layer there are the different news groups. Below each newsgroup there are the different discussion threads, and below each discussion entry there may be replies, each possibly having its own replies. Therefore according to this example the entries of a news system are part of a hierarchy.

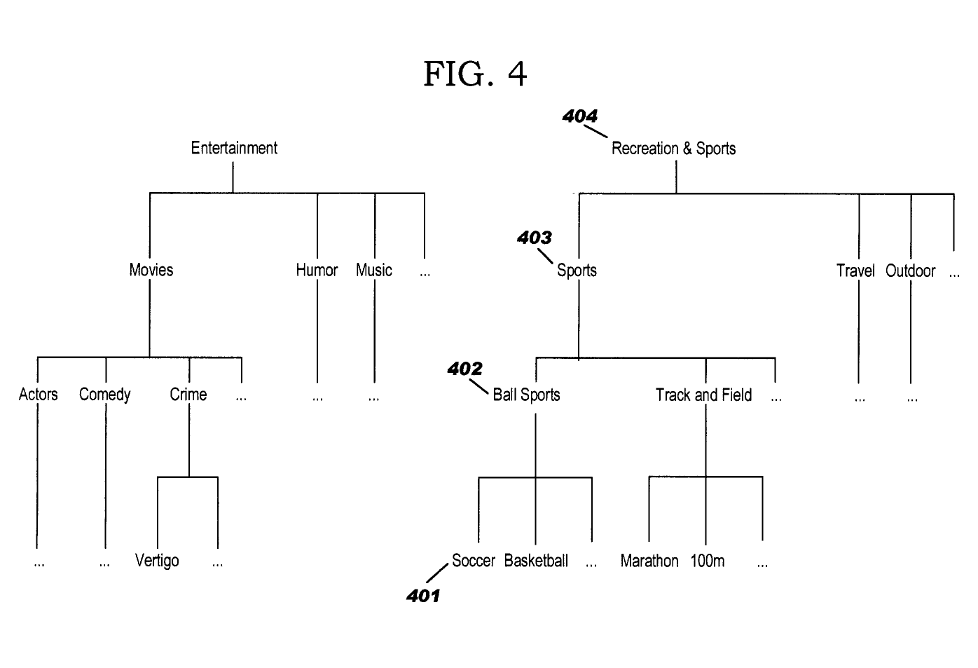

A second example relates to items representing attributes users are allowed to select for specifying their interests. For such items the relationships which can be defined reflect the structuring of a more general item vs a more specific item. Such relationships result in a multitude of hierarchies, or expressed in more technical terms, in a multitude of “trees” or so-called “forests”. This example is reflected for instance in FIG. 4.

Assuming a certain user is explicitly rating item <soccer> 401 then according to the predefined relationship of FIG. 4 a set of related items could consist of the following items: <ball sports> 402, <sports> 403, <recreations & sports> 404. Taking into account for instance a maximum proximity distance of 2, then only the two nearest items according to the relationship would form the set of related items of the explicitly rated item; in the current case, the set of related items would consist only of <ball sports>, <sports>

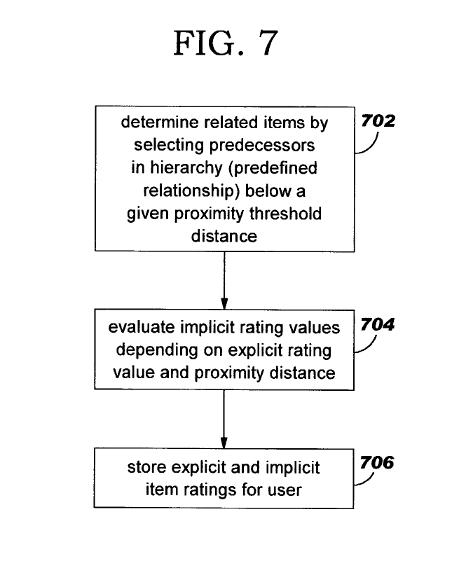

The following method discloses how implicit information can be exploited for implicitly rating the set of related items. This procedure is further described by the flowchart shown in FIG. 7.

Upon receiving a first explicit rating for a first item the following steps may be performed:

determine, for the first item, a first set of one or more related items based on a predefined item relationship (step 702);

calculate implicit ratings for the related items depending on the proximity distance between the first item and each of the related items as well as depending on the explicit rating of the first item (step 704);

store, within the recommendation system, the first explicit rating of said first item (step 706); and

store, within the recommendation system, also the implicit ratings for the set of related item (step 708).

Any type of predefined relationship for the items of the recommendation system can be used within the current teaching; the cases of a hierarchy or in general a directed acyclic graph are specific examples only.

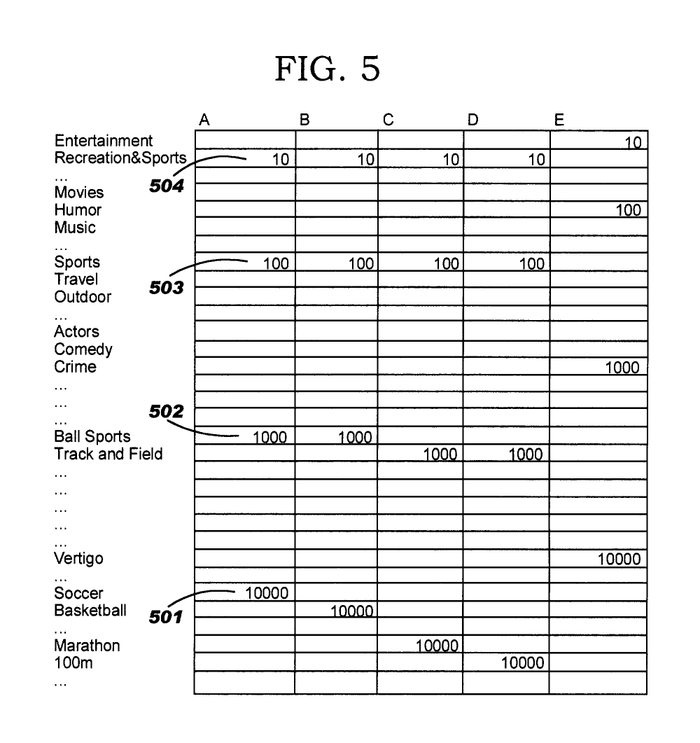

Based on the example of the predefined relationship visualized within FIG. 4 an example for the explicit rating and the derived implicit ratings is visualized within FIG. 5. For readability purposes the rows and columns within FIG. 5 have been switched compared to FIG. 3. FIG. 5 shows, for an exemplary example user/item profile, the explicit rating 501 for item <soccer> with an explicit rating of 10000. The related items <ball sports>, <sports>, <recreations & sports> in terms of the predefined relationship receive implicit ratings 502, 503, 504. The implicit rating values depend on the value of the explicit rating as well as on the proximity distance between the explicitly rated item and each one of the implicitly rated items. As the explicitly rated item is endowed with the highest level of confidence, the calculated implicit ratings decreases with increasing proximity distance.

Based on this explanation the rest of the matrix elements within FIG. 5 can be summarized by the following rating statements:

user A is interested in Soccer

user B is interested in Basketball

user C is interested in Marathon

user D is interested in 100 m, and

user E is interested in Vertigo.

Further Details on the Exploitation of Item Relationships

As indicated above, the present invention improves the recommendation quality. It does so by utilizing external relationships of the items to be rated. By making use of a proximity distance on the item's relationship, it is possible to rate all items related to the item explicitly rated by a user by some implicit rating value depending on the proximity distance of the two items as well as the user's explicit rating value.

Since some related items may be unimportant for increasing the quality of the recommendation system, restriction of the items to those within a proximity distance threshold is useful. Often relationships occur in form of graphs, or more specifically in the form of hierarchies as in the two examples from above (news, attributes).

Here the items of the recommendation system correspond to the nodes in the hierarchy. The introduction of distances attached to the edges and defining the proximity distance between two items as the length of the (shortest) path in the hierarchy, if any, allows for the easy description of the proximity distance between items. Using this notion, the implicitly ratable items for a given explicit item are the predecessors of the given explicit item in the hierarchy upwards until a predefined proximity threshold is reached.

One motivation for this is that explicit interest for Soccer (FIG. 4) likely also means some interest in Ball Sports, Sports, and so forth. It is up to the proximity definitions which predecessors belong to the set of related items, which then are to be incorporated into the implicit rating procedure. Had the hierarchy in FIG. 4 been designed as a single directed tree with a further root node <root> and immediate successors <Entertainment> and <Recreation&Sports>, the restriction to exclude the root node by the proximity threshold would have been meaningful, since otherwise any users having at least one interest would be somehow similar for the recommendation system (because the new item <root> would receive implicit ratings), which is definitely not intended for real systems.

The (simple) approach for determining the rating value for implicitly or explicitly rated items exploited within the example of FIG. 5 is based on the formula

“rating value”=10 ** level

wherein “level” refers to the level of the item to be rated within the hierarchy of the predefined relationship. This is of course an example only; any general function of the form

“rating value of implicit item I”=F(“proximity distance of I”, “rating value of explicit item E”)

could be used.

FIG. 5 shows the case of multiple explicit ratings, wherein each process of calculating and storing the corresponding explicit and implicit ratings is performed independently. This approach will be called “atomic rating” of individual rating requests.

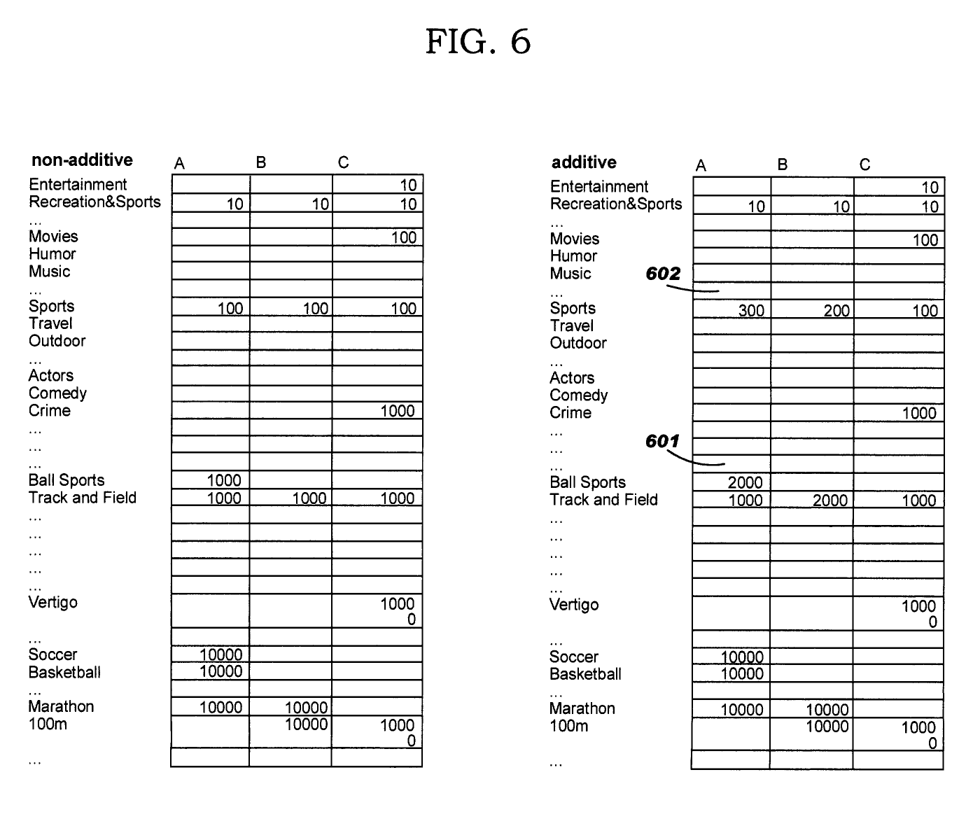

In contrast, FIG. 6 shows various embodiments wherein independent explicit rating requests overlap and can be combined with different results for the explicitly rated items as well as for the implicitly rate items.

According to a first embodiment, whenever a certain implicitly ratable item has been rated already by a first explicit rating request, it is assumed that there is enough information available; if a second explicit rating request would result in a set of related items comprising said certain implicitly rated item already, then the corresponding rating of this item will not be modified when processing the second explicit rating request.

The results of this first embodiment are reflected in the left part of FIG. 6. Assume for instance the ratings of user A as shown FIG. 5 (indicating: user A is interested in<Soccer>). Assume further that user A is then indicating interest in <basketball>. Then, as the set of related items of the item <Soccer> and that of <basketball> are identical, no further implicit rating will be stored in the profiles, as all related items have been already rated within the rating request of <Soccer>. With this interpretation in mind, the left part of FIG. 6 reflects the following requests:

user A is interested in Soccer, Basketball and Marathon,

user B is interested in 100 m and Marathon, and

user C is interested in 100 m and Vertigo.

Within a further embodiment of the current invention an explicit rating provided by a user “overrides” a previous implicit rating of the same user.

In yet another embodiment, each item that is a member of the set of related items of multiple explicit rating requests accumulates the implicit ratings of the individual explicit rating requests. This embodiment is depicted by the right-hand part of FIG. 6. For example user A's explicit rating request of item <basketball> doubles the implicit rating of item <ball sports> 601, as the later is a member of the set of related items of <basketball> as well as of <soccer>. User A's explicit rating request of item <marathon> triples the implicit rating of item <sports> 602, as the later is a member of the set of related items of <basketball>, <marathon> as well as of <soccer>.

When the function for calculating the “rating value of an implicit item I” is expressed as a function F depending on the “distance of item I from the root” of the predefined relationship, it is beneficial for function F to be monotonically increasing with the “distance of item I from the root”. Such an approach will normally ensure that explicit rating values will not be surpassed by implicit rating values.

We claim:

1. A computer method for rating items, for use in a recommendation system, said method comprising the steps of:
determining an explicit rating for an item;
storing the explicit rating in a recommendation system;
determining a set of related items for the item, using the explicit rating and a predefined item relationship;
calculating a set of implicit ratings for the set of related items; and
storing the set of implicit ratings in the recommendation system.

2. A computer method for rating items, for use in a recommendation system, said method comprising the steps of:
determining an explicit rating for a first item;
storing the explicit rating within a recommendation system;
determining a set of related items for the first item, using the explicit rating and a predefined item relationship;
for each item in the set of related items, determining a proximity distance from the first item, using the predefined item relationship;
for each item in the set of related items, calculating a set of implicit rating values using the explicit rating and the proximity distance; and
for each item in the set of related items, storing the set of implicit ratings in the recommendation system.

3. A computerized method for rating items, for use in a recommendation system, said method comprising the steps of:
determining an explicit rating for a first item;
storing the explicit rating in a recommendation system;
determining a set of related items for the first item, using the explicit rating and a predefined item relationship;
for each item in the set of related items, determining a proximity distance from the first item, using the predefined item relationship;
for each item in the set of related items, calculating a set of implicit rating values using the explicit rating and the proximity distance;
determining whether the proximity distance is less than a threshold value; and
for each item in the first set of related items, storing the set of implicit ratings in the recommendation system only if the proximity distance is less than the threshold value.

4. The method of claim 3, wherein:
the predefined item relationship is a directed, acyclic graph;
the first item is represented on the graph by a first-item node; and
items of the set of related items are represented on the graph by nodes that precede the first-item node.

5. The method of claim 4, wherein the proximity distance is defined as a distance within the graph.

6. The method of claim 5, wherein an edge of the graph is associated with a distance value.

7. The method of claim 6, wherein the graph represents a hierarchy.

8. A program storage device readable by a machine, tangibly embodying a program of instructions executable by the machine to perform method steps for rating an item, said method steps comprising:
determining an explicit rating for a first item;
storing the explicit rating in a recommendation system;
determining a set of related items for the first item, using the explicit rating and a predefined item relationship;
for each item in the set of related items, determining a proximity distance from the first item, using the predefined item relationship;
for each item in the set of related items, calculating a set of implicit rating values using the explicit rating and the proximity distance;
determining whether the proximity distance is less than a threshold value; and
for each item in the first set of related items, storing the set of implicit ratings in the recommendation system only if the proximity distance is less than the threshold value.
